(19) United States
(12) Patent Application Publication
(10) Pub. No.: US 2009/0060403 A1
(43) Pub. Date: Mar. 5, 2009

(54) SLEEVE FOR HYDRODYNAMIC BEARING DEVICE, HYDRODYNAMIC BEARING DEVICE EQUIPPED WITH SAME, SPINDLE MOTOR, INFORMATION PROCESSING APPARATUS, AND METHOD FOR MANUFACTURING SLEEVE FOR HYDRODYNAMIC BEARING DEVICE

(76) Inventors: Tsutomu HAMADA, Osaka (JP); Katsuo ISHIKAWA, Ehime (JP); Takafumi ASADA, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/187,689

(22) Filed: Aug. 7, 2008

(30) Foreign Application Priority Data
Aug. 30, 2007 (JP) 2007-224587

(51) Int. Cl. F16C 32/06

(52) U.S. Cl. 384/107

(57) ABSTRACT

A sleeve for a hydrodynamic bearing device, a hydrodynamic bearing device equipped with the sleeve, a spindle motor, information recording and reproducing and processing apparatus, and a method for manufacturing a sleeve for a hydrodynamic bearing device are provided that are capable of reducing costs through appropriate sealing treatment.

The sleeve for a hydrodynamic bearing device has an inner layer and a surface layer. The inner layer is formed by sintering metal powder for sintering use. The surface layer is formed on a surface of the inner layer and includes diiron trioxide (Fe₂O₃). Sealing treatment is carried out by forming a surface layer including diiron trioxide (Fe₂O₃) on a surface of a sleeve for a hydrodynamic bearing device that is porous.

### BACKGROUND OF THE INVENTION

1. Field of the Invention

The present invention relates to a sleeve for a hydrodynamic bearing device used in an information processing apparatus or the like, and particularly relates to a sintered metal sleeve and a hydrodynamic bearing device equipped with the sleeve, a spindle motor, and a method for manufacturing a sleeve for use with an information processing apparatus and the hydrodynamic bearing device. The information processing apparatus referred to here can include apparatuses that drive recording media such as hard disc devices and optical disc devices, and such as personal computers that are information processing apparatus having CPU cooling fans etc.

2. Description of the Related Art

Recording apparatuses and so forth that make use of a rotating disk have grown in memory capacity in recent years, and their data transfer rates have also risen. Therefore, the bearing device used in these recording apparatuses need to offer high reliability and performance for rotating a disk load at a high degree of accuracy. Hydrodynamic bearing devices, which are well suited to high-speed rotation, have been used in these recording apparatuses. With a hydrodynamic bearing device, oil or another such lubricant is interposed between a shaft and a sleeve member, pumping pressure is generated by hydrodynamic grooves during rotation, and this pressure rotates the shaft in non-contact fashion with respect to the sleeve. Because there is no contact between the shaft and the sleeve, there is no mechanical friction, which makes hydrodynamic bearing devices suited to high-speed rotation.

Typically, the sleeve for the hydrodynamic bearing device is manufactured by such as cutting from metallic material such as a ferroalloy or a copper alloy. And, sleeves made of, for example, sintered metal where metal powder such as a copper alloy are molded and sintered have been proposed with the object of further reducing manufacturing costs. However, the sintered metal is an aggregate of metal powder and is therefore porous, containing a multiplicity of pores (small gaps formed between the metal powder). The pores include pores referred to as “compositional pores” that are within a sintered body, and “surface pores” that are opening at the surface of the sintered body. The surface pores and the compositional pores communicate with each other in a normal sintered metal. Lubricant therefore leaks through the pores into the sintered metal so that, for example, support pressure generated by a bearing portion is lowered.

In order to resolve this kind of problem, various technology has been proposed to seal the pores.

For example, in Japanese Patent document 1, a method for manufacturing a hydrodynamic bearing device forming a triiron tetraoxide film (Fe₃O₄) by subjecting the sintered metal body of a material with a multiplicity of pores to water vapor treatment (steam treatment) in an atmosphere of a temperature of 400 to 600 degrees centigrade is disclosed. Processing appropriate for sealing the surface of the sintered metal body is therefore possible.

Patent Document 1: Japanese Patent Publication Laid-open No. 2007-57068

### DISCLOSURE OF INVENTION

### Problem to be solved by the Invention

However, the method for manufacturing the hydrodynamic bearing device of the related art described above has the following problems.

Namely, in the method for manufacturing a hydrodynamic bearing device, it is necessary to strictly manage the amount of oxygen within a furnace during steam treatment and the temperature at the time of exposure to the atmosphere after steam treatment in order to form a triiron tetraoxide (Fe₃O₄) film on the surface of the sintered metal body. There is therefore the problem that the load placed on process management is substantial and that costs become high. In the related art, it was believed that an oxide film for covering the surface of the iron should preferably be triiron tetraoxide that is more stable in intensity as compared with diiron trioxide.

The present invention was conceived to solve these problems encountered in the past, and, it is an object thereof to provide a sleeve for a hydrodynamic bearing device capable of reducing costs for implementing appropriate sealing treatment, a hydrodynamic bearing device equipped with the sleeve, a spindle motor, information processing apparatus, and a method for manufacturing a sleeve for use with a hydrodynamic bearing device.

### SUMMARY OF THE INVENTION

The sleeve for a hydrodynamic bearing device of a first aspect of the invention comprises an inner layer and a surface layer. The inner layer is formed by sintering metal powder for sintering. The surface layer includes Fe₂O₃ formed on a surface of the inner layer.

A surface layer including diiron trioxide (Fe₂O₃) is formed at the surface of the sleeve for the hydrodynamic bearing device formed using metal powder for sintering use and is subjected to pore-sealing treatment.

Sintered metal formed by sintering the metal powder for sintering is porous due to being an aggregate of metal powder and contains a large number of pores. Lubricant therefore leaks through the pores into the sintered metal so that, for example, support pressure generated by a bearing portion may be lowered. Sealing treatment is then carried out in order to block up the pores.

With the sealing treatment of the related art, water vapor treatment (steam treatment) is implemented for a sintered metal body in an atmosphere temperature of 400 to 600 degrees centigrade. A layer of triiron tetraoxide (Fe₃O₄) is then formed on the surface of the porous sintered metal body. However, triiron tetraoxide (Fe₃O₄) that is one iron oxide is chemically unstable. It is therefore necessary to lower the amount of oxygen within the furnace in the steam treatment to a limit in order to form the triiron tetraoxide (Fe₃O₄) layer on the surface of the sintered metal body. Strict processing for opening and closing the sealing of the furnace, vacuum reduction processing within the furnace, and sufficient nitrogen purging are also required. Further, it is necessary to strictly manage temperature at the time of exposure to the atmosphere even for exposure to the atmosphere after steam treatment in order to form chemically unstable triiron tetraoxide (Fe₃O₄). It is therefore necessary to leave the sintered metal body subjected to steam treatment for a long time until the temperature within the furnace falls to 200 degrees centigrade or less. The load placed on process management is therefore substantial and costs become high. With sleeves for hydrodynamic bearing devices of the present invention, sealing treatment takes place where a surface layer including diiron trioxide (Fe₂O₃) that is more chemically stable than the triiron tetraoxide (Fe₃O₄) is formed on the surface of the sleeve for a hydrodynamic bearing device formed using the sintered metal powder.

In the related art, when forming a surface layer including diiron trioxide (Fe₂O₃) on the surface, it was necessary to lower the amount of oxygen in the furnace during the steam treatment down to a limit to achieve sealing treatment using a triiron tetraoxide (Fe₃O₄) layer. This, however, is no longer the case and it is therefore possible to reduce the burden placed on process management. Further, the atmosphere exposure temperature after steam treatment can be set to a high temperature compared to the sealing treatment using triiron tetraoxide (Fe₃O₄). A takt time for the steam treatment can then be made short.

It is therefore possible to reduce the cost of sealing treatment of the porous surface of the sleeve for a hydrodynamic bearing device as appropriate.

The sleeve for a hydrodynamic bearing device of a second aspect of the invention is the sleeve for a hydrodynamic bearing device of the first aspect of the invention where the surface layer is provided with an Fe₃O₄ layer formed at an inner layer-side and an Fe₂O₃ layer formed at a surface side.

Here, the Fe₃O₄ layer is formed on the side of the inner layer of the surface layer and the Fe₂O₃ layer is formed on the surface-side.

Here, the Fe₃O₄ layer can refer to a layer with a substantial portion formed using triiron tetraoxide (Fe₃O₄), or may refer to a layer formed only of triiron tetraoxide (Fe₃O₄) (component proportion ratio of 100 percent). Further, it is also possible to form the Fe₂O₃ layer of diiron trioxide (Fe₂O₃) only as with the Fe₃O₄ layer. It is also possible to provide a mixed layer formed using, for example, Fe₃O₄ and Fe₂O₃ between the Fe₃O₄ layer on the inner layer-side and the Fe₂O₃ layer on the surface-side.

Here, the diiron trioxide (Fe₂O₃) is more chemically stable than the triiron tetraoxide (Fe₃O₄) in one iron oxide of the triiron tetraoxide (Fe₃O₄) oxide and the diiron trioxide (Fe₂O₃).

As a result, it is possible to prevent oxidation of the sleeve for a hydrodynamic bearing device after assembly as a hydrodynamic bearing device.

The sleeve for a hydrodynamic bearing device of a third aspect of the invention is the sleeve for a hydrodynamic bearing device of the second aspect of the invention where the thickness of the Fe₂O₃ layer is 50 percent or less than the thickness of the surface layer.

Here, the thickness of the Fe₂O₃ layer forming the surface of the sleeve for a hydrodynamic bearing device is 50 percent or less than the thickness of the surface layer.

The diiron trioxide (Fe₂O₃) typically has fragile properties. When the layer is thick, part of the layer may become detached or fall off, with such particles then further promoting abrasion.

It is therefore possible to cancel out fragility characteristic of the diiron trioxide (Fe₂O₃) and it is possible to ensure abrasion resistance of the surface of the sleeve for the hydrodynamic bearing device.

The sleeve for a hydrodynamic bearing device of a fourth aspect of the invention is the sleeve for a hydrodynamic bearing device of the second aspect of the invention where the thickness of the Fe₂O₃ layer is two micrometers or less.

Here, the thickness of the Fe₂O₃ layer forming the surface of the sleeve for a hydrodynamic bearing device is two micrometers or less.

The diiron trioxide (Fe₂O₃) typically has fragile properties. When the layer is thick, part of the layer may become detached or fall off, with such particles then further promoting abrasion. It has therefore been considered in the related art to not form the diiron trioxide layer for this reason. However, this problem is resolved and practical use is possible by forming the diiron trioxide layer to an appropriate thickness.

It is therefore possible to cancel out characteristic fragility of the diiron trioxide (Fe₂O₃) and it is possible to ensure abrasion resistance of the surface of the sleeve for the hydrodynamic bearing device.

A hydrodynamic bearing device of a fifth aspect of the invention includes the sleeve for a hydrodynamic bearing device of the first aspects of the invention.

The hydrodynamic bearing device is also provided with a sleeve for a hydrodynamic bearing device that is capable of reducing costs for appropriate sealing treatment.

When a sleeve for a hydrodynamic bearing device formed using sintered metal with the purpose of reducing costs is used but appropriate sealing treatment is not implemented, the support pressure generated by the bearing portion falls. It is therefore impossible to respond to demands for higher performance and reliability called for from the hydrodynamic bearing device.

The above mentioned sleeve for a hydrodynamic bearing device is used in the hydrodynamic bearing device of the present invention.

This means that it is possible to provide a hydrodynamic bearing device having high performance and reliability even when a sleeve for a hydrodynamic bearing device formed using sintered metal in order to reduce costs is used. It is then possible to further reduce manufacturing costs.

A spindle motor of a sixth aspect of the invention is provided with the hydrodynamic bearing device of the fifth aspect of the invention.

Here, the spindle motor is provided with the high performance and reliable hydrodynamic bearing device.

This means that it is possible to provide a high-performance and reliable spindle motor even when a sleeve for a hydrodynamic bearing device formed using sintered metal in order to reduce costs is used. It is then possible to further reduce manufacturing costs.

An information processing apparatus of a seventh aspect of the invention is provided with the spindle motor of the sixth aspect of the invention.

The information processing apparatus is provided with a high-performance and highly reliable spindle motor.

This means that it is possible to provide information processing apparatus having high performance and reliability even when a sleeve for a hydrodynamic bearing device formed using sintered metal in order to reduce costs is used. It is then possible to further reduce manufacturing costs.

A method for manufacturing a sleeve for a hydrodynamic bearing device of an eighth aspect of the invention is provided with a first step and a second step. The first step is steam treatment for a sintered molded body molded and sintered from metal powder for sintering in a furnace. A second step is a step of controlling at least one of partial pressure of oxygen within a furnace and temperature when the furnace is exposed to a gas atmosphere containing oxygen, after the steam treatment processing. Here, the second step of controlling at least one of partial pressure of oxygen within a furnace performing steam treatment and temperature when the furnace is exposed to a gas atmosphere containing oxygen is provided after the first step of typical steam treatment processing. The above steps are typically carried out in a furnace but this does not have to be the case provided that a method is provided that is capable of setting the above conditions for the sintered molded body and its surroundings.

The temperature referred to here refers to the temperature of the sintered molded body formed by steam processing in the first step. By controlling the temperature of the furnace in order to adjust the temperature of the sintered molded body, it may indirectly control the temperature of the sintered molded body. Further, exposure to the atmosphere can be adopted, or exposure to a gas (inert gas, etc.) where the partial pressure of oxygen is controlled can be adopted during exposure of the furnace in the second step.

Sintered metal formed by sintering the metal powder for sintering is then porous due to being an aggregate of metal powder and contains a large number of pores. Lubricating oil therefore leaks through the pores into the sintered metal so that, for example, support pressure generated by a bearing portion may be lowered. Sealing treatment is then carried out in order to cover the pores while manufacturing a sintered metal sleeve for a hydrodynamic bearing device.

One process for sealing treatment of the method for manufacturing a sleeve for a hydrodynamic bearing device of the related art is provided with a step of forming a triiron tetraoxide (Fe₃O₄) layer by subjecting a sintered metal body to steam treatment in an atmosphere of a temperature of 400 to 600 degrees centigrade. However, triiron tetraoxide (Fe₃O₄) that is one iron oxide is chemically unstable. It is therefore necessary to lower the amount of oxygen in the furnace in the steam treatment down to a limit. Consequently, strict processing for opening and closing sealing of the furnace, vacuum reduction processing within the furnace, and sufficient nitrogen purging are required. Further, it is necessary to strictly manage the temperature in the step at the time of exposure to the atmosphere after steam treatment. It is also then necessary for the steam-treated sintered metal body to remain in the furnace for a long time until the temperature within the furnace falls to 200 degrees centigrade or less. A takt time for the steam treatment is therefore long. The load placed on process management is also substantial and costs become high.

The method for manufacturing a sleeve for a hydrodynamic bearing device of the present invention is also provided with a second step of controlling at least one of the partial pressure of the oxygen and the temperature within the furnace, and the partial pressure of the oxygen and the temperature when exposing the furnace to a gas atmosphere containing oxygen after the first step of subjecting the sintered molded body to steam treatment within the furnace. It is therefore possible to form a surface layer including diiron trioxide (Fe₂O₃) on the surface of the molded body formed from sintered metal powder. The above processes (strict processing for opening and closing sealing of the furnace, vacuum reduction processing within the furnace, and sufficient nitrogen purging are required.) for ensuring that diiron trioxide (Fe₂O₃) is not included on the surface in the first step are therefore no longer necessary in this case. The load on the process management can therefore be substantially reduced compared with the burden of strict management in the first step even if the second step is added. Further, after the first step, in the case of, for example, exposure to the atmosphere, the temperature of the sintered molded body subjected to steam treatment can be set to a high temperature compared to the sealing treatment by forming a triiron tetraoxide (Fe₃O₄) layer. It is therefore possible to make the total time until the sintered molded body subjected to steam treatment is cooled to a predetermined temperature short. The takt time for the manufacturing of the sleeve for the hydrodynamic bearing device can then also be made short.

It is therefore possible to reduce the cost of sealing treatment of the sleeve for a hydrodynamic bearing device as appropriate.

The method for manufacturing a sleeve for a hydrodynamic bearing device of a ninth aspect of the invention is the method for manufacturing a sleeve for a hydrodynamic bearing device of the eighth aspect of the invention, where control of the partial pressure of the oxygen in the second step is carried out by purging oxygen so as to be replaced with another gas based on predetermined conditions. Here, “purging” is the replacement of some of the oxygen with another gas. For example, nitrogen purging where oxygen is replaced with nitrogen. Further, for example, the predetermined conditions are conditions where, for example, the partial pressure of the oxygen within the steam treatment furnace is made to not fall below 1×10⁻¹⁴ after steam treatment at approximately 550 degrees centigrade.

Here, for example, flow rate, time, and temperature etc. of the nitrogen purging are regulated so as to ensure that the partial pressure of the oxygen within the steam treatment furnace does not fall below 1×10⁻¹⁴ after steam treatment at approximately 550 degrees centigrade.

As a result, a surface portion of the triiron tetraoxide (Fe₃O₄) can be reliably changed to a diiron trioxide (Fe₂O₃) layer and a diiron trioxide (Fe₂O₃) layer can be reliably formed.

A method for manufacturing a sleeve for a hydrodynamic bearing device of a tenth aspect of the invention is the method for manufacturing a sleeve for a hydrodynamic bearing device of the eighth aspect of the invention where, in the second step, when the sintered molded body within the furnace is exposed to a gas atmosphere containing oxygen, the temperature of the sintered molded body is 300 degrees centigrade or more.

Here, in the second step, the temperature of the sintered molded body subjected to steam treatment during exposure of the sintered molded body within the furnace is controlled to be 300 degrees centigrade or more.

If the temperature of the molded body subjected to steam treatment during exposure of the sintered molded body within the furnace is 200 degrees centigrade or more, a layer of diiron trioxide (Fe₂O₃) can be formed on the surface of the triiron tetraoxide (Fe₃O₄) in theory.

In the present invention, it is possible to change a portion of the surface of a triiron tetraoxide (Fe₃O₄) into a diiron trioxide (Fe₂O₃) layer by controlling the temperature of the molded body subjected to steam treatment during exposure of the sintered molded body within the furnace to be 300 degrees centigrade or more. It is then possible to reliably form a diiron trioxide (Fe₂O₃) layer.

A method for manufacturing a sleeve for a hydrodynamic bearing device of a eleventh aspect of the invention is the method for manufacturing a sleeve for a hydrodynamic bearing device of the tenth aspect of the invention where, a third step of controlling temperature and cooling time for within the furnace or for the sintered molded body within the furnace after exposure of the sintered molded body within the furnace in the second step is further provided.

A third step that controls the temperature and cooling time of the furnace and the sintered molded body is further provided.

It is then possible to form diiron trioxide (Fe₂O₃) layers of various thicknesses of surface layer on the surface of the triiron tetraoxide (Fe₃O₄) in a stable manner.

### EFFECTS OF THE INVENTION

With the sleeve for a hydrodynamic bearing device and the method for manufacturing a sleeve for a hydrodynamic bearing device of the present invention, it is possible to reduce the cost of sealing treatment for the sleeve for the hydrodynamic bearing device in an appropriate manner.

### BRIEF DESCRIPTION OF THE DRAWINGS

FIG. 1 is a cross-section of a spindle motor including a sleeve of an embodiment of the present invention;

FIG. 2 is an enlarged cross-section of a hydrodynamic bearing device included in a spindle motor of FIG. 1;

FIG. 3 is a cross-section of a sleeve included in the hydrodynamic bearing device of FIG. 2;

FIG. 4 is a flowchart showing a method for manufacturing a sleeve of the embodiment of the present invention;

FIG. 5A is a graph showing a relationship between temperature and time for each step of a method for manufacturing a sleeve of the embodiment of the present invention, and FIG. 5B is a graph showing a relationship between temperature and time occurring in each step of a method for manufacturing a sleeve of the related art;

FIG. 6A is an experimental outline view confirming wear and abrasion resistance of a sleeve of the embodiment of the present invention, and FIG. 6B is a graph showing a relationship between layer thickness of the Fe₂O₃ layer and the amount of abrasion of the Fe₂O₃ layer.

FIG. 7 is a flowchart showing a method for manufacturing a sleeve of a another embodiment of the present invention;

FIG. 8 is a flowchart showing a method for manufacturing a sleeve of another embodiment of the present invention;

FIG. 9 is a cross-section of a spindle motor including a sleeve of another embodiment of the present invention; and

FIG. 10 is a cross-section showing a structure for an information recording and reproducing and processing apparatus including a hydrodynamic bearing device of another embodiment of the present invention.

### DETAILED DESCRIPTION OF THE INVENTION

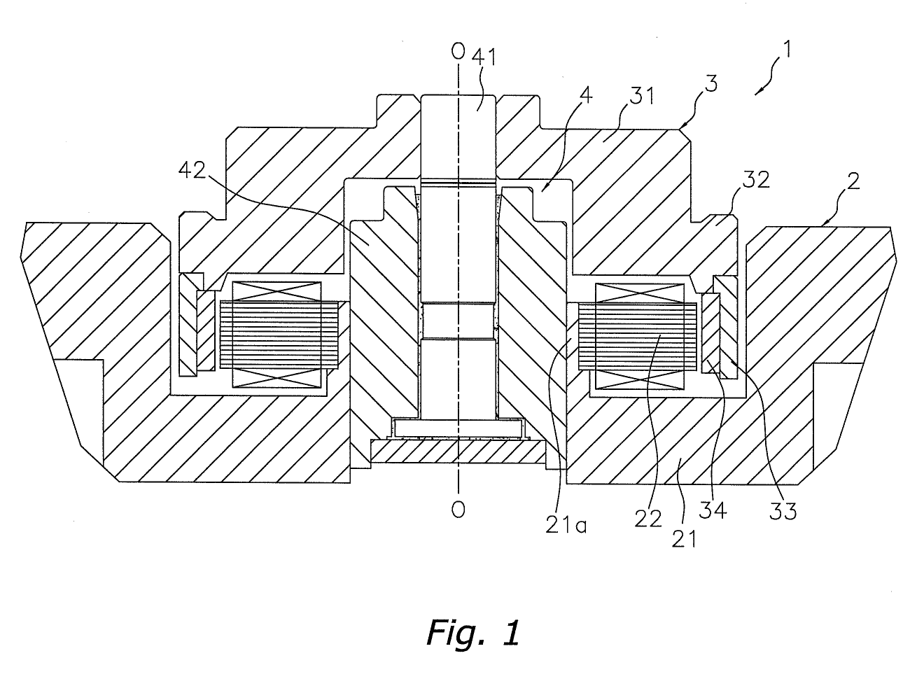

A spindle motor 1 including a sleeve for a hydrodynamic bearing device (hereinafter referred to as “sleeve”) 42 of an embodiment of the present invention is described in the following using FIG. 1 to FIG. 6.

### Overall Configuration of the Spindle Motor 1

An outline vertical cross-section of a spindle motor 1 equipped with a hydrodynamic bearing device 4 adopting a sleeve 42 is shown as this embodiment in FIG. 1. O-O shown in FIG. 1 is an axis of rotation of the spindle motor 1. In the description of this embodiment, for convenience, upper and lower directions in the drawings are referred to as “upward axial direction” and “downward axial direction”, etc., and the actual manner in which the spindle motor 1 is fitted is by no means limited.

The spindle motor 1 mainly includes a base plate 2, a rotor 3, and a hydrodynamic bearing device 4.

The base plate 2 is configured from a portion on a static side of the spindle motor 1 and is fixed to, for example, a housing (not shown) of the recording disc apparatus or is constituted a housing. The base plate 2 has a bracket portion 21. A stator 22 is attached on the bracket portion 21. The base plate 2 is formed from a non-magnetic aluminum metallic material (for example, ADC 12 etc.) or a magnetic iron metallic material (for example, SPCC, SPCD, etc.). The bracket portion 21 has a cylindrical section 21a extending to the side in an upward axial direction at an inner periphery side. The stator 22 is configured from a magnetic circuit and is fixed to an outer peripheral side of the cylindrical section 21a. The hydrodynamic bearing device 4 described in the following is fixed to an inner peripheral side of the cylindrical section 21a.

The rotor 3 is a portion rotated by rotational force generated by a magnetic circuit and has a rotor hub 31, a disc mounting section 32, a back yoke 33, and a rotor magnet 34. The rotor hub 31 is a portion constituting a main essential part of the rotor 3 and is fixed to a shaft 41 described later. The rotor hub 31 is made of stainless steel (for example, DHS1, etc.) which is an iron-based metal material or aluminum metallic material (for example, A6061, etc.). The disc mounting section 32 is for mounting a recording disc (not shown) and is disposed at an outer periphery side in a downward axial direction of the rotor hub 31. In this embodiment, the rotor hub 31 and the disc mounting section 32 are formed integrally.

The back yoke 33 is a cylindrical member fixed in a downward axial direction of the rotor hub 31 and to the inner peripheral side of the disc mounting section 32. The back yoke 33 is formed from a magnetic iron metallic material (for example, SPCC, SPCD, etc.). The rotor magnet 34 is fixed to the inner periphery side of the back yoke 33 and is disposed facing the stator 22 in the radial direction. A bond magnet where neodymium, iron, and boron are bound together using a binder such as a resin is used as the rotor magnet 34, so as to polarize multipole in a circumferential direction. In a small motor, when the rotor hub is a magnetic body, forming by integration with the back yoke is common. The rotor magnet 34 and the stator 22 then form a magnetic circuit that rotates the rotor. Namely, a rotating magnetic field is created by sequentially exciting the coil of the stator 22. As a result, rotational force is generated at the rotor magnet 34 and the rotor 3 is rotated. The rotor 3 is supported in a freely rotatable manner with respect to the base plate 2 by the hydrodynamic bearing device 4.

### Structure of the Hydrodynamic Bearing Device 4

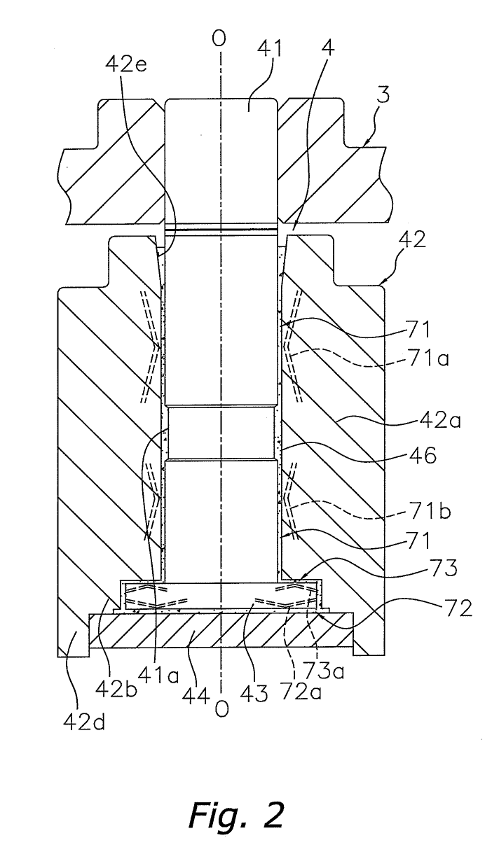

An outline vertical cross-section of the hydrodynamic bearing device 4 is shown in FIG. 2. The hydrodynamic bearing device 4 supports the rotor 3 in a freely rotatable manner with respect to the base plate 2 and has the sleeve 42, the shaft 41, a thrust plate 44, and a thrust flange 43 fixed to or formed integrally with the shaft 41. The shaft 41 is formed of stainless steel (for example, SUS 420, SUS 303, etc.) that is an iron-metallic material. The thrust plate 44 is formed of stainless steel (for example, SUS 420, etc.) of an iron-metallic material or hardened steel (for example, FB10, etc.). The thrust flange 43 is formed of stainless steel (for example, SUS 303, etc.) of an iron-metallic material.

The sleeve 42 is a member of the stationary side of the hydrodynamic bearing device 4 and is a cylindrical sintered metal member inserted to the inner peripheral side of the cylindrical section 21a of the base plate 2 (refer to FIG. 1). Iron sintered metal is used here. The sleeve 42 has a sleeve body 42a, at least one (more than one in this case) first hydrodynamic grooves 71a, 71b, a cylindrical projection 42b, a fixed section 42d, and a seal 42e. The sleeve body 42a is a cylindrical member constituting the main essential section of the sleeve 42. The first hydrodynamic grooves 71a, 71b are grooves formed at the inner peripheral surface of the sleeve body 42a disposed at equal intervals in a circumferential direction and have, for example, like a herring bone pattern. The cylindrical projection 42b is an annular portion projecting in an axial direction from an end of the sleeve body 42a. The fixed section 42d is an annular portion moreover projecting in an axial direction from an end of the cylindrical projection 42b. The fixed section 42d is, for example, attached to the outer periphery side of the thrust plate 44 by using epoxy adhesive or caulking. The seal 42e is a capillary seal formed at the inner periphery side of the upper end in an axial direction of the sleeve body 42a.

The shaft 41 is a member of the rotation side of the hydrodynamic bearing device 4 and is a columnar member disposed at the inner periphery side of the sleeve 42. The shaft 41 has a recess 41a. The recess 41a is an annular recessed portion formed at the outer peripheral surface of the shaft 41 and is disposed at a position corresponding to between axial directions of the first hydrodynamic grooves 71a and 71b. The recess 41a can also be formed at the side of the sleeve 42.

The thrust flange 43 is a member of the rotation side of the hydrodynamic bearing device 4 and is fixed to an end of the shaft 41. The thrust flange 43 is disposed at the inner periphery side of the cylindrical projection 42b of the sleeve 42 (the thrust flange 43 can also be formed integrally with the shaft 41). Specifically, the thrust flange 43 is disposed via a minute clearance as a spaces formed between the sleeve 42 and the thrust plate 44. The thrust flange 43 has a second hydrodynamic groove 72a at a surface facing the thrust plate 44 in an axial direction. Further, the thrust flange 43 has a third hydrodynamic groove 73a at a surface facing the sleeve body 42a in an axial direction. The second hydrodynamic groove 72a can be formed at the thrust plate 44 and the third hydrodynamic groove 73a can be formed at an end of the sleeve 42.

At the hydrodynamic bearing device 4, sleeve 42 having the first hydrodynamic grooves 71a and 71b, shaft 41, and lubricating oil 46 as a lubricant interposed between the sleeve 42 and the shaft 41 constitute a radial bearing portion 71 supporting the rotor 3 in the radial direction. Here, it is possible to use high-fluidity grease or ionic fluid as lubricant in addition to lubricating oil. Further, the thrust flange 43 having the second hydrodynamic groove 72a, the thrust plate 44 and lubricating oil 46 interposed between the thrust flange 43 and thrust plate 44 constitute a main thrust bearing portion 72 supporting the rotor 3 in the axial direction. Moreover, the thrust flange 43 having the third hydrodynamic groove 73a, the sleeve 42 and lubricating oil 46 interposed between the thrust flange 43 and the sleeve 42 constitute a sub-thrust bearing portion 73. Support force in a radial direction and axial direction of the shaft 41 is generated at each bearing portions as a result of relative rotation of each member. The sleeve 42 can therefore be said to be an extremely important member for the hydrodynamic bearing device 4.

### Details of the Sleeve 42

As described above, the sleeve 42 of an embodiment of the present invention is made of sintered metal. The sintered metal sleeve is made by forming and sintering of fine particles rather than by cutting work or the like from metal material base metals in order to reduce manufacturing costs. The characteristics of sintered metal are now explained in detail.

The sintered metal is made by forming and sintering metal powders and therefore contains large numbers of pores (small gaps formed between the metal powder). The pores include pores referred to as “compositional pores” that are within a sintered body, and “surface pores” that are openings at the surface of the sintered body. Typically, lubricating oil passes through within the sintered metal through the pores with sintered metal sleeves because the surface pores and the compositional pores communicate. As shown in FIGS. 1 and 2, when the sleeve 42 of the hydrodynamic bearing device 4 is made from sintered metal, with no modification to this situation the lubricating oil 46 passes to within the sleeve 42. The lubricating oil 46 then passes through the pores within the sleeve 42 and support pressure generated by the radial bearing portion 71 is dispersed to the outer periphery side of the sleeve 42. As a result, for example, the support pressure generated at the radial bearing portion 71 falls and the stiffness of the radial bearing portion 71 falls.

With the sleeve 42 for the present invention, sintered metal is subjected to pore sealing treatment that seals the pores in order to reduce the extent of soaking of the lubricating oil 46.

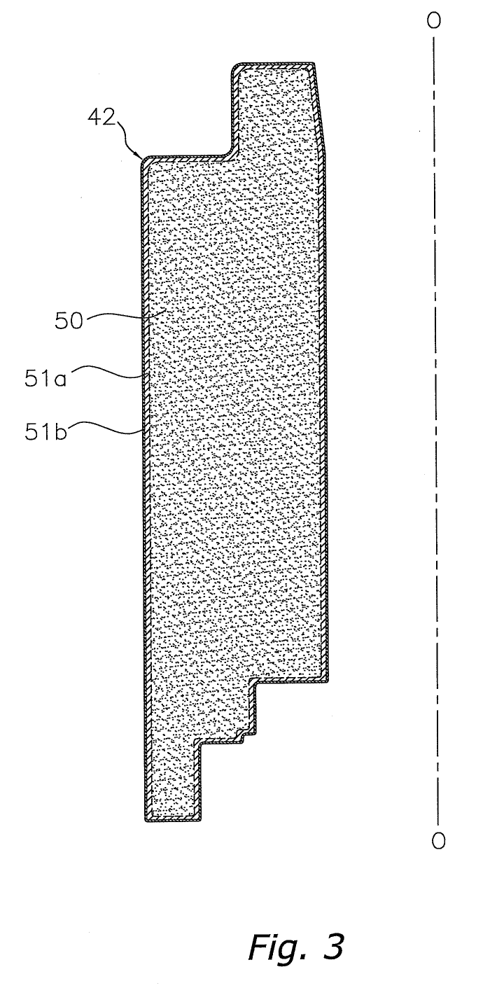

A description is now given using the outline vertical cross-section of the sleeve 42 shown in FIG. 3 of the content of the pore sealing treatment.

The sleeve 42 mainly includes an inner layer 50 and a surface layer 51.

The inner layer 50 is a cylindrical portion formed from metal powder for sintering use and sintered.

The surface layer 51 is a dense, stable oxide film that covers the surface of the inner layer 50. The surface layer 51 has an Fe₃O₄ layer 51a (a layer including 50% or more of triiron tetraoxide (Fe₃O₄)) formed from triiron tetraoxide (Fe₃O₄) on the surface of the inner layer 50, and an Fe₂O₃ layer 51b (a layer including 50% or more of diiron trioxide (Fe₂O₃)) formed from diiron trioxide (Fe₂O₃) at the surface of the Fe₃O₄ layer 51a, i.e. formed at the surface of the sleeve 42. Mixed layers where both triiron tetraoxide (Fe₃O₄) and diiron trioxide (Fe₂O₃) are mixed between the Fe₃O₄ layer 51a and the Fe₂O₃ layer 51b can also be formed. There are also cases where an FeO layer of iron oxide (FeO) is formed at the lower layer of the Fe₃O₄ layer 51a. The surface layer 51 appropriately seals the pores of the sleeve 42 that is porous and made by sintering. At the sleeve 42 of this embodiment, the thickness of the surface layer 51 is 1.0 micrometers, that breaks down into about 0.7 micrometers of Fe₃O₄ layer 51a, and about 0.3 micrometers of Fe₂O₃ layer 51b.

As a result, it is possible to appropriately seal the pores on the surface of the sleeve 42. It is also possible to prevent support pressure of the radial bearing portion 71 from being dispersed through the pores above mentioned and members etc. covering the outer periphery of the sleeve 42 are no longer necessary. It is therefore possible to reliably reduce manufacturing costs.

### Method for Manufacturing the Sleeve 42

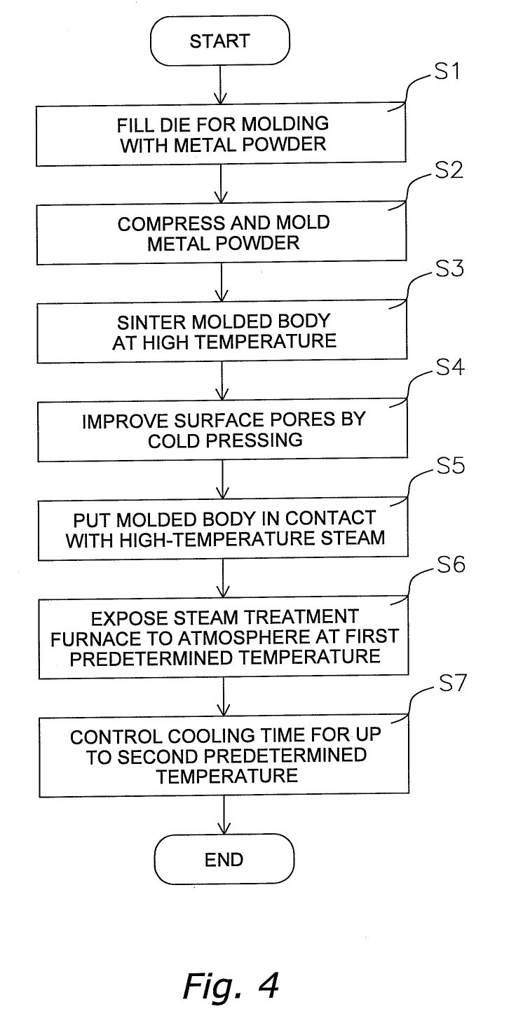

A detailed description is given in the following of the sleeve 42 of an embodiment of the present invention and a method for manufacturing the sleeve 42. A flowchart of a method for manufacturing the sleeve 42 of this embodiment is shown in FIG. 4. As shown in FIG. 4, this manufacturing method includes steps S1 to S7. Steps S1 to S4 outline a process for making a sintered molded body, although the sintered molded body can also be made using methods other than those shown below.

In step S1, for example, a die for molding is filled up with metal powder including iron.

In step S2, for example, the metal powder material filled in in step S1 is then compressed using upper and lower dies for molding and a molded body is formed.

In step S3, the molded body compressed in step S2 is sintered at high-temperature.

In step S4, the molded body is then processed in a cold press (sizing) and surface pores of the molded body are improved. As a result, it is possible to make large surface pores that cannot be sealed using oxide film formed in post processing small. This means that more reliable surface sealing treatment is possible.

The sleeve of the molded body molded and sintered from metal powder as described above is subjected to sealing treatment of the embodiment of the invention of this application.

In step S5 (the first step), the molded body sintered in step S3 is subjected to water vapor treatment (steam treatment). Specifically, the molded body is mounted within a steam treatment furnace. The molded body is then exposed to high-temperature steam of, for example, approximately 500 degrees centigrade for approximately thirty minutes to two hours. The surface of the molded body is then oxidized at a high-temperature. As a result, as shown in reaction formula (1) below, oxidation takes place in order from the surface side of the molded body. It is then possible to form the surface layer 51 including the triiron tetraoxide (Fe₃O₄) at the surface of the molded body.

3Fe+4H₂O [symbol] Fe₃O₄+4H₂ (1)

In step S6 (the second step), the molded body subjected to steam treatment in step S5 is cooled to a first predetermined temperature and exposed to the atmosphere. At this time, the temperature of the molded body within the steam treatment furnace is managed so as not to fall below 300 degrees centigrade. As a result, it is possible for the surface layer 51 containing the triiron tetraoxide (Fe₃O₄) and to newly react with oxygen in the atmosphere. An Fe₂O₃ layer of diiron trioxide (Fe₂O₃) is then formed on the surface of the surface layer 51, as shown in reaction formula (2) below.

4Fe₃O₄+O₂ [symbol] 6Fe₂O₃ (2)

As a result, the surface portion of the Fe₃O₄ layer 51a of triiron tetraoxide (Fe₃O₄) formed in step S5 is changed, and an Fe₂O₃ layer of newly oxidized diiron trioxide (Fe₂O₃) is formed. In this embodiment, the atmosphere exposed to is air but can also be other atmospheres such as, for example, a gas (an inert gas such as nitrogen) containing oxygen.

In step S7 (the third step), cooling time is controlled until the temperature of the molded body within the steam treatment furnace after being exposed to the atmosphere in step S6 becomes a second predetermined temperature (approximately 200 degrees centigrade). As a result, it is possible to form a stable Fe₂O₃ layer. In this embodiment, the second predetermined temperature is taken to be 200 degrees centigrade but this is by no means limited. It is not essential for the molded body to be left in the steam treatment furnace and control of the temperature of the molded body is also possible after taking the molded body to outside of the steam treatment furnace. This time is for one to five minutes but this is also not limited. It is also possible to form the diiron trioxide (Fe₂O₃) layer just with the second step, even without the third step, but forming the same layer thickness will take time.

It is therefore possible to form the surface layer 51 from the Fe₃O₄ layer 51a of a layer thickness of approximately 0.7 micrometers and an Fe₂O₃ layer 51b of a layer thickness of approximately 0.3 micrometers at the surface of the sleeve 42 by making the sleeve 42 using the conditions explained above.

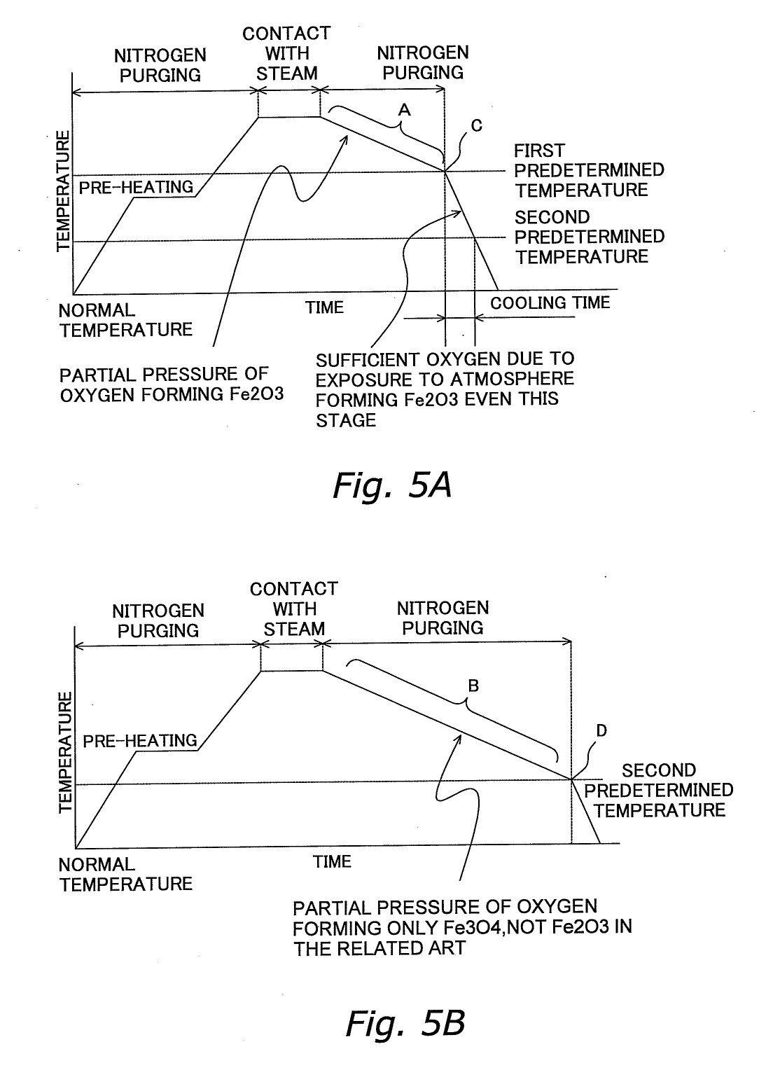

The steam treatment of this embodiment and the steam treatment for forming the Fe₃O₄ layer formed from only triiron tetraoxide (Fe₃O₄) as in the related art (hereinafter shown as steam treatment of the related art) are compared using FIG. 5A and FIG. 5B, respectively.

In the steam treatment, first, partial pressure of the oxygen is reduced by nitrogen purging before coming into contact with the steam (the oxygen in the furnace is substituted with nitrogen). The surface of the molded body is therefore prevented from being oxidized more than is necessary during heating. This treatment is treatment both manufacturing methods of steam treatment occurring in this embodiment and steam treatment of the related art have in common. It is also possible to use other inert gases in place of the nitrogen in the purge processing.

Next, the molded body is made to come into contact with the high-temperature steam for approximately 30 minutes to two hours when the inside of the steam treatment furnace is sufficiently heated (in this embodiment, approximately 500 degrees centigrade). In this way, it is possible to oxidize the surface of the molded body in a high-temperature state (refer to reaction formula (1) below).

3Fe+4H₂O→Fe₃O₄+4H₂ (1)

This process is also a process common to both manufacturing methods as described above.

Next, residual oxygen remaining after the molded body makes contact with the high-temperature steam is managed. Specifically, partial pressure of oxygen within the steam treatment furnace is controlled by carrying out the nitrogen purging for a predetermined time and a predetermined quantity of flow.

Next, the steam treatment furnace is exposed to the atmosphere. In the method for manufacturing a sleeve of the related art, it was necessary to expose the furnace to the atmosphere after sufficiently lowering the temperature within the steam treatment furnace to, for example, 200 degrees centigrade or the like to ensure that new oxidation reactions do not occur with the oxygen in the atmosphere. It was therefore necessary for a sufficient amount of time to elapse after the high-temperature steam comes into contact with the molded body. This means that exposure to the atmosphere could not take place until the point (second predetermined temperature) corresponding to D shown in FIG. 5B. On the other hand, with the manufacturing method for the embodiment of the present invention, partial pressure of the oxygen within the furnace is made higher than in the related art in order to ensure that a new oxidation reaction (refer to reaction formula (2) below) reliably occurs between the surface layer containing the triiron tetraoxide (Fe₃O₄) formed on the surface of the molded body and the oxygen in the atmosphere. Exposure to the atmosphere then takes place with the temperature of the steam treatment furnace at, for example, 300 degrees centigrade etc. (first predetermined temperature).

4Fe₃O₄+O₂ [symbol] 6Fe₂O₃ (2)

The surface layer 51 containing the triiron tetraoxide (Fe₃O₄) and the oxygen in the atmosphere then react, an Fe₃O₄ layer for a surface portion of the surface layer 51 is newly oxidized, and an Fe₂O₃ layer is formed. As a result, after the high-temperature steam comes into contact with the molded body, it is possible to expose the furnace to the atmosphere at a point (first predetermined temperature) corresponding to C shown in FIG. 5A. It is therefore possible to make the processing time short compared to the manufacturing method for the related art.

As shown above, it is possible to make the time until the steam treatment furnace is exposed to the atmosphere substantially shorter compared to the manufacturing method for the related art and it is therefore possible to make a takt time for the steam treatment short. This means that it is possible to reduce the cost for subjecting the sleeve 42 to appropriate sealing treatment.

### FIRST EMBODIMENT

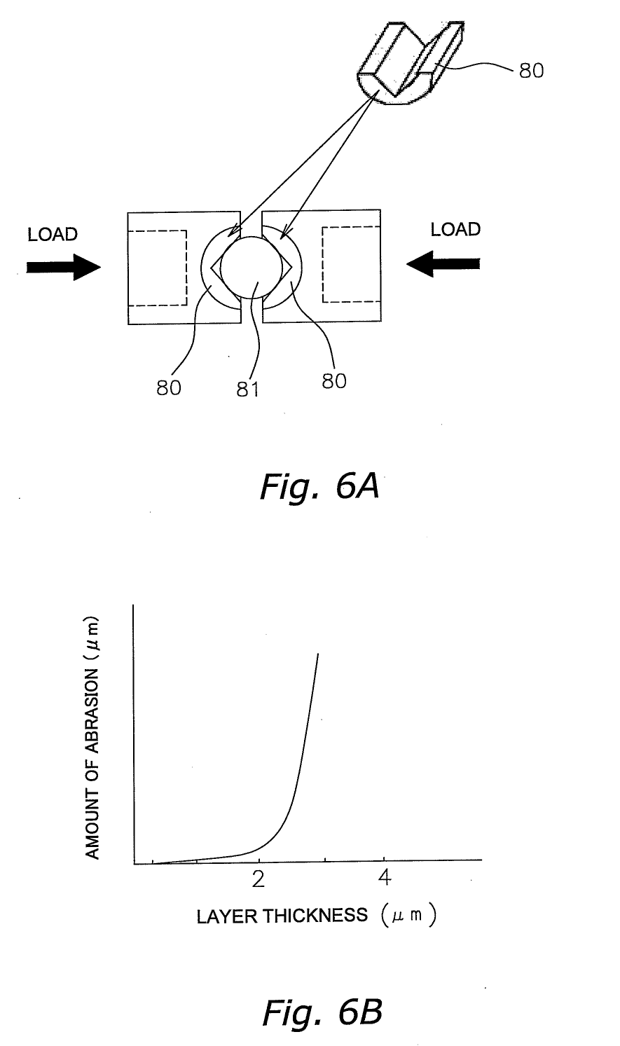

Experimentation is carried out to confirm abrasion resistance of the sleeve 42 formed with the Fe₂O₃ layer 51b. Specifically, as shown in FIG. 6A, a test piece 80 with a V-shaped cross-section formed with the Fe₂O₃ layer 51b is pushed onto a rotating shaft 81. The amount of abrasion (abrasion depth/width) of the Fe₂O₃ layer in this case is then measured.

Accordingly, it is possible to obtain the results of FIG. 6B showing the relationship between the layer thickness of the Fe₂O₃ layer 51b and the amount of abrasion of the Fe₂O₃ layer. It can then be confirmed that the amount of abrasion rapidly increases when the layer thickness of the Fe₂O₃ layer forming on the surface of the sleeve 42 is thicker than 2 micrometers.

It is assumed that the amount of abrasion dramatically increases when the layer thickness of the Fe₂O₃ layer is thicker than 2 micrometers for the following reasons.

The first reason is that the Fe₂O₃ of layer is typically fragile. This means that peeling and coming off starts from roughly when the layer thickness of the Fe₂O₃ layer exceeds 2 micrometers. The fragments that is peeled or come off then come into contact with the Fe₂O₃ layer and abrasion of the Fe₂O₃ layer is further increased.

Secondly, the surface of the Fe₂O₃ layer typically have the nature of rougher as the layer thickness becomes thicker. The surface of the test piece therefore makes point contact, i.e. makes contact in a state where stress is substantial. The Fe₂O₃ layer is then easily subject to abrasion. The generated abrasion powder then comes into contact with the Fe₂O₃ layer and abrasion of the Fe₂O₃ layer is increased.

It is therefore preferable for the layer thickness of the Fe₂O₃ layer formed on the surface of the sleeve 42 to be two micrometers or less. In the method for manufacturing the sleeve 42 of this embodiment, an Fe₂O₃ layer 0.3 micrometers thick is formed and sufficient wear and abrasion resistance is therefore exhibited.

### Features of the Spindle Motor 1

(1)

With the spindle motor 1 of this embodiment, a surface layer 51 including diiron trioxide (Fe₂O₃) is formed on the surface of the sleeve 42 and sealing treatment is performed.

As a result, it is possible to set the atmospheric exposure temperature after steam treatment high compared to the sealing treatment formed from just the triiron tetraoxide (Fe₃O₄). It is then possible to make takt times for the steam treatment short. This means that it is possible to reduce the cost for subjecting the sleeve 42 to appropriate sealing treatment.

(2)

With the spindle motor 1 of this embodiment, the surface layer 51 includes at least two layers of the Fe₃O₄ layer 51a formed from triiron tetraoxide (Fe₃O₄) on the inner layer 50-side, and the Fe₂O₃ layer 51b formed from diiron trioxide (Fe₂O₃) on the surface side.

The porous surface of the sleeve 42 is then appropriately sealed and it is possible to make the surface more stable. It is also possible to prevent oxidation after the sleeve 42 is assembled as the hydrodynamic bearing device 4.

(3)

With the spindle motor 1 of this embodiment, the thickness of the surface layer 51 is 1.0 micrometers, which breaks down into about 0.7 micrometers of Fe₃O₄ layer 51a, and about 0.3 micrometers of Fe₂O₃ layer 51b. The thickness of the Fe₂O₃ layer 51b is 50 percent or less of the thickness of the surface layer 51.

It is therefore possible to cancel out fragility characteristic of the diiron trioxide Fe₂O₃ and it is possible to ensure wear and abrasion resistance of the surface of the sleeve 42.

(4)

The Fe₃O₄ layer 51a is 2.0 micrometers or less for the spindle motor 1 of this embodiment.

It is therefore possible to cancel out fragility characteristic of the diiron trioxide (Fe₂O₃) and it is possible to ensure wear and abrasion resistance of the surface of the sleeve 42.

### Features of the Method for Manufacturing the Sleeve 42

(1)

In the method for manufacturing the sleeve 42 of this embodiment, as shown in FIG. 4, after the steam treatment of step S5, step S6 is provided to control the temperature of the steam treatment furnace upon being exposed to the atmosphere.

It is therefore possible to form a surface layer 51 including the Fe₂O₃ layer 51b of the diiron trioxide (Fe₂O₃) at the surface of the molded body molded from the sintered metal powder. In this case, it is possible to set the atmosphere exposure temperature after step S5 to a high temperature compared to forming the surface layer 51 just from the Fe₃O₄ layer of triiron tetraoxide (Fe₃O₄). It is possible to make the takt time in step S5 to step S7 short. This means that it is possible to reduce the cost for subjecting the sleeve 42 to appropriate sealing treatment.

(2)

The method for manufacturing the sleeve 42 of this embodiment is such that the temperature of the molded body in the steam treatment furnace is 300 degrees centigrade or more during exposure of the steam treatment furnace in step S6.

It is therefore possible to form the Fe₂O₃ layer 51b of diiron trioxide (Fe₂O₃) more effectively on the surface of the Fe₃O₄ layer 51a of the triiron tetraoxide (Fe₃O₄).

(3)

In the method for manufacturing the sleeve 42 of this embodiment, as shown in FIG. 4, after the exposing of the steam treatment furnace in step S6, step S7 is further provided to control the cooling time for up to when the temperature of the molded body in the steam treatment furnace reaches the second predetermined temperature.

It is therefore possible to form the Fe₂O₃ layer 51b of diiron trioxide (Fe₂O₃) stably on the surface of the Fe₃O₄ layer 51a of the triiron tetraoxide (Fe₃O₄).

### FURTHER EMBODIMENTS

A description is given in the above of an embodiment of the present invention but the present invention is by no means limited to the above embodiment and various modifications are possible without deviating from the essence of the invention.

### (A)

In the method for manufacturing the sleeve 42 of the embodiment explained above, an example is given of controlling temperature of the molded body during exposing of the steam treatment furnace to the atmosphere after the steam treatment of step S5. The present invention is, however, not limited to this.

For example, it is possible to obtain the same results as the method for manufacturing the sleeve 42 of the above embodiment even when controlling the oxygen partial pressure of the steam treatment furnace (residual oxygen) as step S6 after the steam treatment of step S5.

Specifically, for example, after steam treatment at approximately 550 degrees centigrade, the partial pressure of the oxygen within the steam treatment furnace is controlled so as not to fall below 1×10⁻¹⁴. It is therefore possible to form the surface layer 51 including diiron trioxide (Fe₂O₃) as one iron oxide at the surface of the molded body.

This is then compared with steam treatment that forms the Fe₃O₄ layer using only the triiron tetraoxide (Fe₃O₄) of the related art.

Oxide partial pressure control of the steam treatment furnace in step S6 corresponds to A shown in FIG. 5A in this embodiment and corresponds to B shown in FIG. 5B in the manufacturing method of the related art.

Oxide partial pressure control is specifically carried out by purging the steam treatment furnace of nitrogen for a predetermined time and a predetermined quantity of flow. In the method for manufacturing a sleeve of the related art, it is necessary to carry out nitrogen purging to a sufficient extent and to strictly manage the partial pressure of the oxygen (amount of residual oxygen) at a location corresponding to B of FIG. 5B in order to make the amount of residual oxygen extremely small. Specifically, the partial pressure of the oxygen is strictly managed so as to be less than 1×10⁻¹⁴. Decompression processing or the like such as using strict seal processing or a vacuum pump or the like is necessary in order to implement these environments. On the other hand, in the manufacturing method of this embodiment of the present invention, it is sufficient to perform management so that the partial pressure of the oxygen becomes not less than 1×10⁻¹⁴ at the location corresponding to A in FIG. 5A. This environment can therefore be satisfied in a typical steam treatment furnace even without strictly managing the residual oxygen. The manufacturing method of the present invention is therefore capable of substantially reducing the load with regards to managing residual oxygen in the steam treatment furnace after steam treatment compared to the manufacturing method for the related art.

In step S6, control validity so that the partial pressure of the oxygen within the steam treatment furnace becomes higher than 1×10⁻¹⁴ when the temperature of the molded body is approximately 550 degrees centigrade is verified.

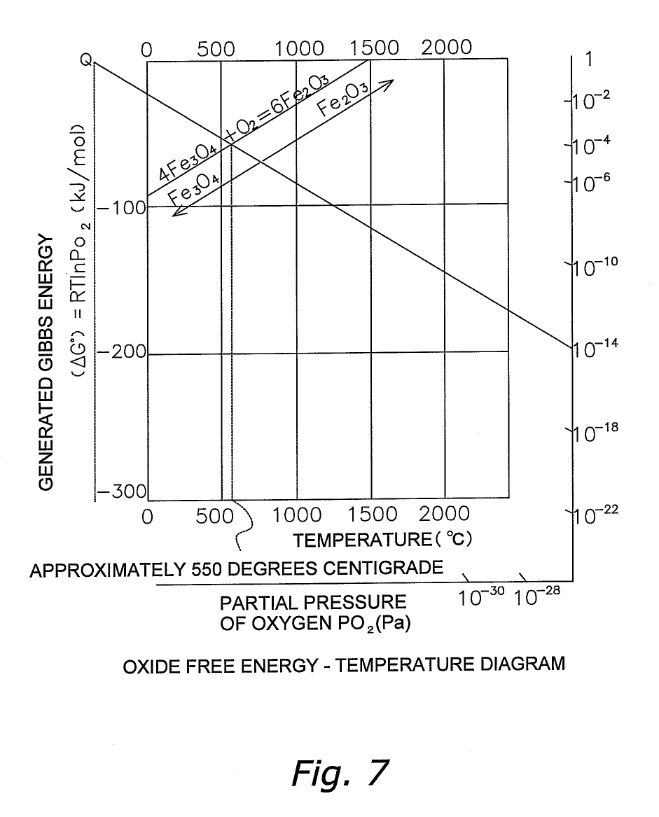

FIG. 7 is a diagram of free energy of oxides versus temperature, and is referred to as an Ellingham diagram. FIG. 7 is a graph plotting standard generated energy occurring at each temperature for various oxides showing temperature on the horizontal axis and Gibbs energy on the vertical axis. It is therefore possible to know from the diagram what kind of reducing agent is required to act at how temperature in order to reduce the metal oxide to a metal. Further, it is also possible to know whether the metal can exist without being oxidized under certain partial pressure of oxygen.

In step S5, steam treatment is carried out at a temperature of approximately 550 degrees centigrade as explained above. When a state of approximately 550 degrees centigrade is confirmed in the reaction for 4Fe₃O₄+O₂=6Fe₂O₃, as shown in FIG. 7, it is possible to confirm whether a reaction in the direction of Fe₃O₄ (reduction) can take place easily or whether a reaction in the direction of Fe₂O₃ (oxidation) can take place easily taking an oxygen partial pressure of 1×10⁻¹⁴ as a threshold value. Accordingly, it can be confirmed that propagation in the direction of generation of Fe₂O₃ occurs easily if the partial pressure of the oxygen is in excess of 1×10⁻¹⁴ in the reaction 4Fe₃O₄+O₂=6Fe₂O₃ occurring at approximately 550 degrees centigrade. As a result, in step S6, in order to form the Fe₂O₃ layer 51b of Fe₂O₃, validity of control to ensure that the partial pressure of the oxygen in the steam treatment furnace becomes higher than 1×10⁻¹⁴ with the temperature of the molded body at approximately 550 degrees centigrade is carried out.

According to the Ellingham diagram shown in FIG. 7, when the temperature of the molded body is lower than approximately 550 degrees centigrade, the partial pressure of the oxygen to be controlled is a value smaller than 1×10⁻¹⁴. When the temperature of the molded body is higher than approximately 550 degrees centigrade, it can be understood that the partial pressure of the oxygen to be controlled to becomes a value larger than 1×10⁻¹⁴.

### (B)

In the method for manufacturing the sleeve 42 of the above embodiment, in the steam treatment of step S5, a description is given of an example of making contact with high-temperature steam for approximately thirty minutes to two hours within an atmosphere of a temperature of 500 degrees centigrade. The present invention is, however, not limited to this.

For example, it is also possible to make contact with the high-temperature steam in an atmosphere temperature of 580 degrees centigrade for two hours. In this case, it is possible to form a surface layer of Fe₃O₄ with a layer thickness of 5.0 micrometers at the surface of the sleeve. Namely, it is possible to form surface layers of various thicknesses by controlling the temperature and time for the steam treatment.

The manufacturing method of this embodiment does not limited to atmosphere temperature within the steam treatment furnace and steam treatment time. The layer thickness of the Fe₃O₄ layer changes by controlling the atmosphere temperature within the steam treatment furnace and the steam treatment time.

### (C)

In the method for manufacturing the sleeve 42 of the embodiment explained above, an example is given of controlling temperature of the molded body during exposing the steam treatment furnace to the atmosphere after the steam treatment in step S5. The present invention is, however, not limited to this.

For example, after the steam treatment of step S5, it is also possible to control the partial pressure of the oxygen (residual oxygen) within the steam treatment furnace and control the temperature of the molded body when exposing the steam treatment furnace to the atmosphere.

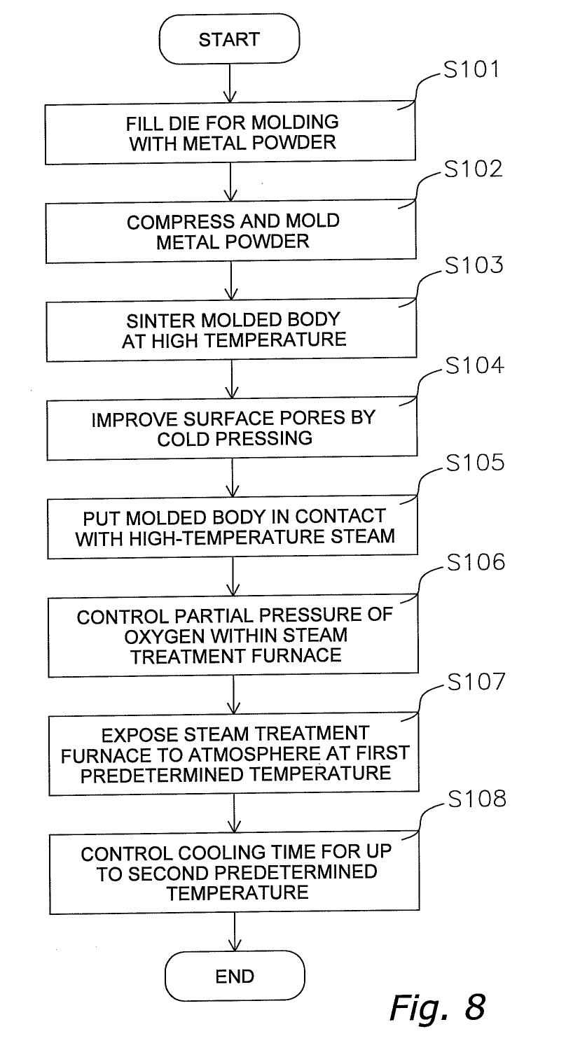

In this case, the process for forming the surface layer that is the oxide film at the surface of the sleeve is carried out in the order of filling a die for molding with metal powder (step S101), compressing and molding the metal powder (step S102), sintering the molded body at a high temperature (step S103), improving the surface pores by cold pressing (step S104), putting the molded body into contact with high-temperature steam (step S105), controlling the partial pressure of the oxygen of the steam treatment furnace (step S106), exposing the steam treatment furnace to the atmosphere at a first predetermined temperature (step S107), and controlling the temperature and cooling time after exposing to the atmosphere (step S108), as shown in FIG. 8. It is preferable for the film thickness of the Fe₂O₃ layer further formed on the surface layer of the Fe₃O₄ layer obtained in this manner to be 2.0 micrometers or less, or 50 percent or less of the whole of the surface layer section from the point of view of wear and abrasion resistance.

### (D)

In the method for manufacturing the sleeve 42 of the embodiment explained above, an example is given of controlling temperature and cooling time of the molded body after exposing to the atmosphere in step S7. The present invention is, however, not limited to this.

Step S7 is a step for forming an arbitrary layer thickness and is not an essential step. Even if step S7 is omitted, it is possible to form the Fe₃O₄ layer of triiron tetraoxide (Fe₃O₄) directly on the surface of the inner layer and the Fe₂O₃ layer of diiron trioxide (Fe₂O₃) on the surface of the Fe₃O₄ layer.

### (E)

In the method for manufacturing the sleeve 42 of the embodiment explained above, an example is given of directly controlling the temperature of the molded body in step S6 and step S7. The present invention is, however, not limited to this.

For example, it is also possible to control the temperature within the steam treatment furnace to indirectly control the temperature of the molded body.

### (F)

An example is explained of water vapor treatment (steam treatment) for forming an oxidation film for the spindle motor 1 of the above embodiment. The present invention is, however, not limited to this.

For example, it is also possible to form a triiron tetraoxide (Fe₃O₄) film using carbon dioxide. The method shown in claim 8 can be used as the method for forming a diiron trioxide (Fe₂O₃) film on the surface layer of the triiron tetraoxide (Fe₃O₄) film formed using this method. When carbon dioxide is used, installation becomes cheaper because water pipes and dedicated water heating apparatus is unnecessary. If pure carbon dioxide is used then it is possible to form a pure oxide film with no foreign matter attached.

### (G)

Regarding the spindle motor 1 of the above embodiment, an example is given of application of the sleeve 42 of a embodiment of the present invention to a hydrodynamic bearing device 4 as shown in FIG. 1. The present invention is, however, not limited to this.

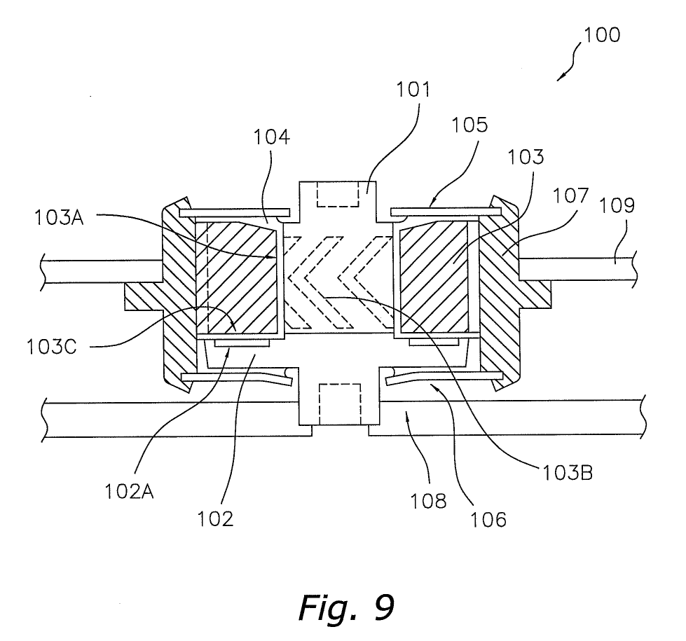

For example, it is possible to obtain the same results as for the spindle motor 1 of the above embodiment by also applying the sleeve 103 of an embodiment of the present invention to the hydrodynamic bearing device 100 shown in FIG. 9. The following is a description of the hydrodynamic bearing device 100.

As shown in FIG. 9, the hydrodynamic bearing device 100 includes a shaft 101, a flange 102, a sleeve 103, oil 104, an upper cover 105, a lower cover 106, a rotor 107, and a base 108.

The shaft 101 is formed integraly with the flange 102. The shaft 101 is inserted into a bearing hole 103A of the sleeve 103 so as to be freely rotatable in a relative manner. The flange 102 is disposed facing the lower surface of the sleeve 103. A hydrodynamic groove 103B is provided at at least one of the outer peripheral surface of the shaft 101 or the inner peripheral surface of the sleeve 103. A hydrodynamic groove 102A is also provided at least one of the sleeve lower surface 103C or a surface of the flange 102 facing the sleeve lower surface 103C. The upper cover 105 and the lower cover 106 are fixed to the sleeve 103 or the rotor 107. Bearing clearance in the vicinity of each of the hydrodynamic grooves 103B, 102A is at least filled by lubricating oil 104. The disc 109 is fixed to the rotor 107. The shaft 101 is fixed to the base 108. A rotor magnet (not shown) is fitted to the rotor 107. A motor stator (not shown) is fixed to the base 108 at a position facing the rotor magnet. The spindle motor is used as a motor used to rotate a disc recording medium but can also be used as a fan motor with a fan attached. It is also used as a CPU cooling fan actually for personal computer.

### (H)

A description is given in the above embodiment of an example of the sleeve 42 of the embodiment of the present invention applied to the spindle motor 1. The present invention is, however, not limited to this.

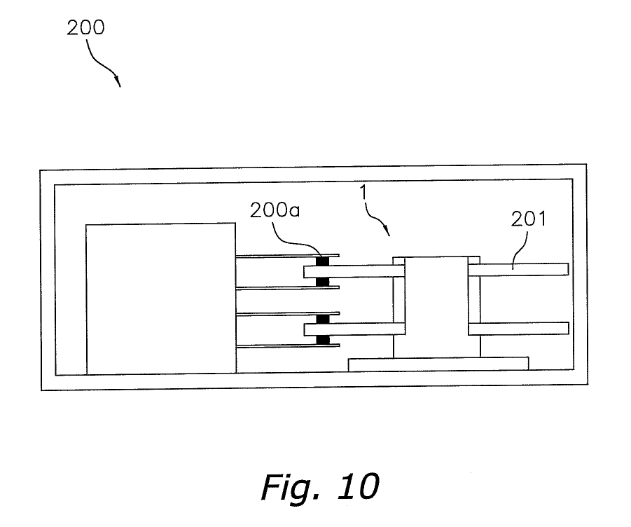

For example, as shown in FIG. 10, the present invention can also be applied to an information recording and reproducing and processing apparatus (information processing apparatus) 200 in which the spindle motor 1 having the above constitution is installed, and which reproduces information recorded to the recording disc 201 with a recording head 200a, or records information to the recording disc 201.

This means that it is possible to provide the information recording and reproducing and processing apparatus 200 having high performance and reliability even when a sleeve 42 formed using sintered metal in order to reduce costs is used. It is then possible to further reduce manufacturing costs.

### Field of Industrial Utilization

With the sleeve for a hydrodynamic bearing device and the method for manufacturing a sleeve for a hydrodynamic bearing device of the present invention, it is possible to reduce costs for manufacturing a sleeve for the hydrodynamic bearing device appropriately subjected to sealing treatment. It is also possible to prevent degrading of bearing stiffness. This is therefore particularly useful when applied to the spindle motors and information and processing apparatus requiring high degrees of performance and reliability.

What is claimed is:

1. A sleeve for a hydrodynamic bearing device comprising:
an inner layer formed by sintering metal powder for use in sintering; and
a surface layer containing Fe₂O₃ formed on a surface of the inner layer.

2. The sleeve for a hydrodynamic bearing device according to claim 1, wherein the surface layer comprises an Fe₃O₄ layer formed at the inner layer-side, and an Fe₂O₃ layer formed at a surface side.

3. The sleeve for a hydrodynamic bearing device according to claim 2, wherein the thickness of the Fe₂O₃ layer is 50 percent or less than the thickness of the surface layer.

4. The sleeve for a hydrodynamic bearing device according to claim 2, wherein the thickness of the Fe₂O₃ layer is 2 micrometers or less.

5. A hydrodynamic bearing device comprising the sleeve for a hydrodynamic bearing device according to claim 1.

6. A spindle motor comprising the hydrodynamic bearing device according to claim 5.

7. An information processing apparatus comprising the spindle motor according to claim 6.

8. A method for manufacturing a sleeve for a hydrodynamic bearing device comprising:
a first step of steam treating a sintered molded body molded sintered metal powder, and forming an Fe₃O₄ layer;
a second step of controlling at least one of partial pressure of oxygen and temperature surrounding the sintered molded body, and the partial pressure of oxygen and temperature when exposing the sintered molded body to a gas atmosphere containing oxygen after the first step so as to form an Fe₂O₃ layer on a surface layer of the Fe₃O₄ layer.

9. The method for manufacturing a sleeve for a hydrodynamic bearing device according to claim 8, wherein control of partial pressure of oxygen in the second step is performed by purging oxygen through substitution with another gas based on predetermined conditions.

10. The method for manufacturing a sleeve for a hydrodynamic bearing device according to claim 8, wherein, in the second step, the temperature of the sintered molded body when the sintered molded body is exposed to a gas atmosphere containing oxygen is 300 degrees centigrade or more.

11. The method for manufacturing a sleeve for a hydrodynamic bearing device according to claim 8, further comprising a third step of controlling temperature and cooling time of the sintered molded body after exposing the sintered molded body in the second step.
